(19) United States
(12) Patent Application Publication
(10) Pub. No.: US 2026/0254517 A1
(43) Pub. Date: Aug. 27, 2026

(54) ENHANCED UPLINK AND DOWNLINK BEAM SELECTION USING CANDIDATE COMPONENT CARRIER REDUCTION

(71) Applicant: QUALCOMM Incorporated, San Diego, CA (US)

(72) Inventors: Kang GAO, San Diego, CA (US); Jun ZHU, San Diego, CA (US); Ruhua HE, San Diego, CA (US); Surendra KOMPALA, Dublin, CA (US); Raghu Narayan CHALLA, San Diego, CA (US)

(21) Appl. No.: 19/065,428

(22) Filed: Feb. 27, 2025

(51) Int. Cl. H04B 7/06; H04L 5/00

(52) U.S. Cl. CPC H04B 7/06952; H04L 5/0098

(57) ABSTRACT

Methods, systems, and devices for wireless communications are described. Some wireless communications systems may support enhanced uplink and downlink beam selection using candidate component carrier reduction. A network entity may transmit, to a user equipment (UE), a component carrier configuration indicating multiple component carriers for communications by the UE. The UE may receive one or more reference signals via a set of component carriers, of the multiple component carriers, that are associated with an active use duration that is greater than a threshold duration. The active use duration for a component carrier may be a combined duration for which the UE actively communicates via the component carrier during an observation window. The UE may communicate using a beam, from multiple candidate beams supported by the UE, that is associated with a reference signal, of the received reference signals, having a metric that satisfies one or more beam selection conditions.

### FIELD OF TECHNOLOGY

The following relates to wireless communications, including enhanced uplink and downlink beam selection using candidate component carrier reduction.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving control signaling that indicates a set of multiple component carriers for communications by the UE, receiving one or more reference signals via a set of component carriers, where the set of component carriers includes one or more component carriers, of the set of multiple component carriers indicated via the control signaling, that are associated with an active use duration that is greater than a threshold duration, where the active use duration for a component carrier includes a combined duration over which the UE actively communicates via the component carrier during an observation window, and communicating using a beam that is selected from a set of multiple candidate beams supported by the UE based on measurements of the one or more reference signals, where the beam is associated with a reference signal, of the one or more reference signals, having a metric that satisfies one or more beam selection conditions.

A UE for wireless communications is described. The UE may include one or more memories storing processor executable code, a transceiver, and one or more processors coupled with the one or more memories and the transceiver. The one or more processors may be configured cause the UE to receive, via the transceiver, control signaling that indicates a set of multiple component carriers for communications by the UE, receive, via the transceiver, one or more reference signals via a set of component carriers, where the set of component carriers includes one or more component carriers, of the set of multiple component carriers indicated via the control signaling, that are associated with an active use duration that is greater than a threshold duration, where the active use duration for a component carrier includes a combined duration over which the UE actively communicates via the component carrier during an observation window, and communicate using a beam that is selected from a set of multiple candidate beams supported by the UE based on measurements of the one or more reference signals, where the beam is associated with a reference signal, of the one or more reference signals, having a metric that satisfies one or more beam selection conditions.

Another UE for wireless communications is described. The UE may include means for receiving control signaling that indicates a set of multiple component carriers for communications by the UE, means for receiving one or more reference signals via a set of component carriers, where the set of component carriers includes one or more component carriers, of the set of multiple component carriers indicated via the control signaling, that are associated with an active use duration that is greater than a threshold duration, where the active use duration for a component carrier includes a combined duration over which the UE actively communicates via the component carrier during an observation window, and means for communicating using a beam that is selected from a set of multiple candidate beams supported by the UE based on measurements of the one or more reference signals, where the beam is associated with a reference signal, of the one or more reference signals, having a metric that satisfies one or more beam selection conditions.

A non-transitory computer-readable medium storing code for wireless communications is described. The code may include instructions executable by one or more processors to receive control signaling that indicates a set of multiple component carriers for communications by the UE, receive one or more reference signals via a set of component carriers, where the set of component carriers includes one or more component carriers, of the set of multiple component carriers indicated via the control signaling, that are associated with an active use duration that is greater than a threshold duration, where the active use duration for a component carrier includes a combined duration over which the UE actively communicates via the component carrier during an observation window, and communicate using a beam that is selected from a set of multiple candidate beams supported by the UE based on measurements of the one or more reference signals, where the beam is associated with a reference signal, of the one or more reference signals, having a metric that satisfies one or more beam selection conditions.

Some examples of the method, UEs, and non-transitory computer-readable medium described herein may further include operations, features, means, or instructions for receiving one or more second reference signals via a second set of component carriers, where the second set of component carriers includes one or more downlink component carriers, of the set of multiple component carriers indicated via the control signaling, that may be associated with respective second active use durations that may be greater than a second threshold duration, and where the set of component carriers includes one or more uplink component carriers.

In some examples of the method, UEs, and non-transitory computer-readable medium described herein, the set of component carriers includes a first quantity of component carriers that may be different from a second quantity of component carriers included in the second set of component carriers and the set of component carriers includes at least one component carrier that may be not included in the second set of component carriers, the second set of component carriers includes at least one component carrier that may be not included in the set of component carriers, or both.

Some examples of the method, UEs, and non-transitory computer-readable medium described herein may further include operations, features, means, or instructions for communicating using a second beam that may be selected from the set of multiple candidate beams supported by the UE based on second measurements of the one or more second reference signals, where the second beam includes a downlink beam associated with a second reference signal, of the one or more second reference signals, having a second metric that satisfies the one or more beam selection conditions, and where the beam includes an uplink beam.

In some examples of the method, UEs, and non-transitory computer-readable medium described herein, a second metric of a second reference signal for selection of a second beam of the set of multiple candidate beams may be different from as the metric of the reference signal associated with the beam and used for selection of the beam based on the beam including an uplink beam and the second beam including a downlink beam.

Some examples of the method, UEs, and non-transitory computer-readable medium described herein may further include operations, features, means, or instructions for measuring respective values of the metric associated with each reference signal of the one or more reference signals and selecting the beam from the set of multiple candidate beams based on a value of the metric associated with the reference signal satisfying the one or more beam selection conditions, where communicating using the beam may be based on selecting the beam.

Some examples of the method, UEs, and non-transitory computer-readable medium described herein may further include operations, features, means, or instructions for measuring respective values of the metric associated with each reference signal of the one or more reference signals and selecting the beam from the set of multiple candidate beams based on an average value of the metric across the one or more reference signals satisfying the one or more beam selection conditions, where communicating using the beam may be based on selecting the beam.

Some examples of the method, UEs, and non-transitory computer-readable medium described herein may further include operations, features, means, or instructions for communicating via the set of multiple component carriers during the observation window, measuring, for each component carrier of the set of multiple component carriers based on communicating during the observation window, a respective active use duration for each component carrier, and selecting the set of component carriers from among the set of multiple component carriers based on the respective active use durations for each component carrier of the set of component carriers exceeding the threshold duration, where receiving the one or more reference signals via the set of component carriers may be based on the selecting.

In some examples of the method, UEs, and non-transitory computer-readable medium described herein, measuring the respective active use duration for each component carrier may include operations, features, means, or instructions for measuring, for each component carrier of the set of multiple component carriers, a first respective active use active use duration over which the UE actively exchanges uplink signaling via the component carrier while communicating during the observation window, where a respective uplink active use duration may be based on the first respective active use duration and measuring, for each component carrier of the set of multiple component carriers, a second respective active use duration over which the UE actively exchanges downlink signaling via the component carrier while communicating during the observation window, where a respective downlink active use duration may be based at least on part on the second respective active use duration.

In some examples of the method, UEs, and non-transitory computer-readable medium described herein, the threshold duration includes a threshold for inclusion of respective component carriers in the set of component carriers and a second threshold duration includes a threshold for inclusion of respective component carriers in a second set of component carriers.

In some examples of the method, UEs, and non-transitory computer-readable medium described herein, the respective active use duration for the component carrier includes a ratio between the respective duration over which the UE actively exchanges signaling via the component carrier and a second duration of the observation window.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports enhanced uplink and downlink beam selection using candidate component carrier reduction in accordance with one or more aspects of the present disclosure.

FIG. 2 shows an example of a wireless communications system that supports enhanced uplink and downlink beam selection using candidate component carrier reduction in accordance with one or more aspects of the present disclosure.

FIG. 3 shows an example of a process flow that supports enhanced uplink and downlink beam selection using candidate component carrier reduction in accordance with one or more aspects of the present disclosure.

FIGS. 4 and 5 show block diagrams of devices that support enhanced uplink and downlink beam selection using candidate component carrier reduction in accordance with one or more aspects of the present disclosure.

FIG. 6 shows a block diagram of a communications manager that supports enhanced uplink and downlink beam selection using candidate component carrier reduction in accordance with one or more aspects of the present disclosure.

FIG. 7 shows a diagram of a system including a device that supports enhanced uplink and downlink beam selection using candidate component carrier reduction in accordance with one or more aspects of the present disclosure.

FIGS. 8 through 10 show flowcharts illustrating methods that support enhanced uplink and downlink beam selection using candidate component carrier reduction in accordance with one or more aspects of the present disclosure.

### DETAILED DESCRIPTION

Some wireless communications systems may support beam selection using multiple component carriers. For example, a user equipment (UE) may select a beam based on measuring reference signals received via a primary component carrier (PCC) in addition to other component carriers (e.g., secondary component carriers (SCCs)) configured for communications between the UE and a network entity. To support multi-component carrier beam selection, the UE may measure reference signals received via each component carrier, and may select a beam that corresponds to a reference signal that has one or more metrics which satisfy one or more beam selection conditions. However, the UE may not actively communicate via all of the multiple configured component carriers, and different component carriers may be used for uplink and downlink communications. Thus, limiting reference signal measurement for uplink and downlink beam selection to the component carriers via which the UE actively communicates uplink and downlink communications, respectively, may be beneficial to reduce latency and overhead associated with multi-component carrier beam selection.

Accordingly, techniques, systems, and devices described herein enable limiting reference signal measurements for beam selection to measurements of reference signals and corresponding beams received via a set of component carriers via which the UE communicates for an active use duration that is greater than a threshold duration. Reducing the quantity of candidate component carriers that the UE considers during beam selection in multi-component carrier beam selection scenarios may reduce latency and overhead, among other examples. For example, the UE may receive a configuration that activates multiple component carriers for communications between the UE and a network entity. The UE may measure the active use duration for each component carrier by measuring a duration over which the UE actively communicates via the component carrier during an observation window (e.g., a percentage of active use within the observation window). The UE may select a subset of component carriers that have an active use duration that is greater than the threshold duration. The UE may select separate subsets for active uplink and downlink component carriers, in some examples. The selected subset(s) may be used by the UE as candidates for beam selection. For example, the UE may measure reference signals received via the selected subset(s), and the UE may select a beam associated with one of the measured reference signals that has a metric that satisfies one or more beam selection conditions. Thus, the UE may limit the quantity of component carriers considered during multi-component carrier beam selection based on the active use duration of the component carriers, which may reduce latency and overhead and overhead associated with multi-component carrier beam selection.

Aspects of the disclosure are initially described in the context of wireless communications systems. Additional aspects are further illustrated by and described with reference to process flow diagrams. Aspects of the disclosure are further illustrated by and described with reference to apparatus diagrams, system diagrams, and flowcharts that relate to enhanced uplink and downlink beam selection using candidate component carrier reduction.

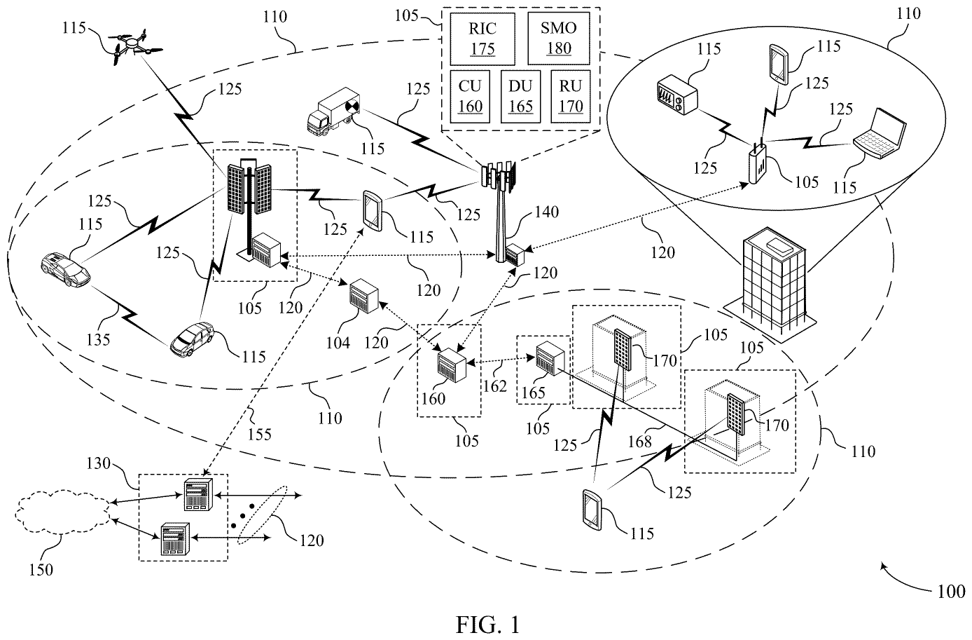

FIG. 1 shows an example of a wireless communications system 100 that supports enhanced uplink and downlink beam selection using candidate component carrier reduction in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support enhanced uplink and downlink beam selection using candidate component carrier reduction as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some examples of the wireless communications system 100, a network entity 105 may transmit control signaling to one or more UEs 115 indicating a component carrier configuration for communications by the one or more UEs 115. The component carrier configuration may include one or more component carriers that the UE 115 may use for beam selection procedures. For instance, the UE 115 may select a beam based on measuring reference signals (e.g., synchronization signal blocks (SSBs), CSI-RSs, demodulation reference signals (DMRS)) received via a PCC as well as one or more SCCs configured for communications by the UE 115 by the component carrier configuration. In multi-component carrier beam selection scenarios, the UE 115 may receive the reference signals via each component carrier indicated by the component carrier configuration, and the UE 115 may measure the reference signals received via each component carrier. However, the UE 115 may not actively communicate via all the multiple configured component carriers and different component carriers may be used for uplink and downlink communications. Thus, limiting reference signal measurement for uplink and downlink beam selection to the component carriers via which the UE actively communicates uplink and downlink communications, respectively, may be beneficial to reduce latency and overhead associated with multi-component carrier beam selection.

The techniques described herein provide for limiting reference signal measurements for beam selection to measurements of reference signals and corresponding beams received via a set of component carriers via which the UE 115 communicates for an active use duration that is greater than a threshold duration. Reducing the quantity of candidate component carriers that the UE 115 considers (e.g., measures, selects reference signals from) during beam selection in multi-component carrier beam selection scenarios may reduce latency and overhead, among other examples. For example, the UE 115 may receive a configuration that activates multiple component carriers for communications between the UE 115 and a network entity 105, and the UE 115 may measure the active use duration for each component carrier by measuring a duration over which the UE 115 actively communicates via the component carrier during an observation window. The UE 115 may select a subset of component carriers that have an active use duration that is greater than the threshold duration.

In some examples, the UE 115 may select separate subsets for active uplink and downlink component carriers. The selected subset(s) may be used by the UE 115 as candidates for beam selection. For example, the UE 115 may measure reference signals received via the selected subset(s), and the UE 115 may select a beam associated with one of the measured reference signals that has a metric that satisfies one or more beam selection conditions. Thus, the UE 115 may limit the quantity of component carriers considered during multi-component carrier beam selection based on the active use duration of the component carriers.

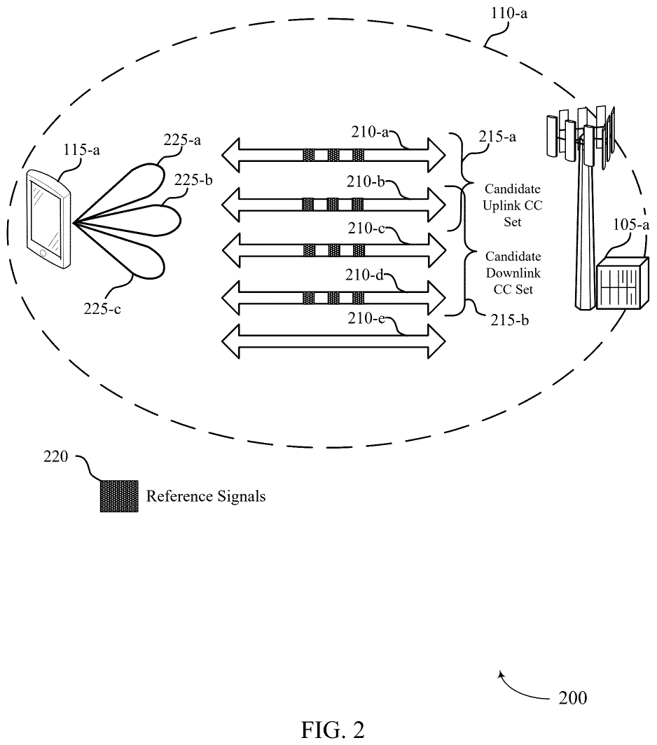

FIG. 2 shows an example of a wireless communications system 200 that supports uplink and downlink beam selection using candidate component carrier reduction in accordance with one or more aspects of the present disclosure. The wireless communication system 200 may implement or be implemented by aspects of the wireless communications system 100 as described with reference to FIG. 1. For example, the wireless communication system 200 may include a network entity 105-a and a UE 115-a, which may represent examples of a network entity 105 and a UE 115, respectively, or some other types of devices, as described with reference to FIG. 1. The network entity 105-amay communicate with the UE 115-a within a geographic coverage area 110-a. In this example, the network entity 105-a may transmit control signaling, to the UE 115-a, indicating multiple component carriers 210 for communications by the UE 115-a. The UE 115-a may communicate via a set of component carriers (e.g., candidate uplink component carrier set 215-a and/or candidate downlink component carrier set 215-b) of the multiple component carriers 210 indicated by the network entity 105-a, and may use the component carriers 210 within the set of component carriers 215 for beam selection procedures.

In some examples of the wireless communications system 100, the UE 115-a may use one or more component carriers 210 configured by the network entity 105-a for beam selection procedures. For instance, in multi-component carrier beam selection scenarios, the UE 115-a may receive reference signals 220 via each of the component carriers 210 configured by the network entity 105-b, and the UE 115-a may measure the reference signals 220 received via each component carrier 210. However, the UE 115-a may not actively communicate via all the configured component carriers 210, and different component carriers 210 may be used for uplink and downlink communications. Thus, limiting reference signal measurement for uplink and downlink beam selection to the component carriers 210 via which the UE 115-a actively communicates uplink and downlink communications, respectively, may be beneficial to reduce latency and overhead associated with multi-component carrier beam selection.

To improve uplink and downlink beam selection in multi-component carrier beam selection scenarios, techniques, systems, and devices described herein provide for the UE 115-a to limit reference signal measurements for beam selection to measurements of reference signals and corresponding beams received via a set of component carriers 215 via which the UE 115 communicates for an active use duration that is greater than a threshold duration. For example, the UE 115-a may communicate via the multiple component carriers 210 configured by the network entity 105-a during an observation window, which may be some duration of milliseconds, slots or other unit of time (e.g., 20 ms, 30 ms, 50 ms) that may be configured at the UE 115-a or otherwise indicated to the UE 115-a (e.g., via control signaling). The UE 115-a may measure, for each component carrier 210, an active use duration within the observation window. The active use duration for a component carrier 210 may be a duration (e.g., a respective quantity of milliseconds) that the UE 115-a actively exchanges signaling via the component carrier 210. In some examples, the active use duration may be expressed as a percentage or ratio between a combined duration over which the UE 115-a actively exchanges signaling via the component carrier 210 during the observation window and the duration of the entire observation window. The combined duration of active use may be contiguous or, in some examples, may be discontinuous bursts of communications interleaved with breaks (e.g., no signaling via the component carrier 210) during the observation window.

In some examples, the UE 115-a may measure a combined (e.g., cumulative) active use duration for each component carrier 210, where the active use duration includes a duration of use for uplink and downlink communications. Additionally, or alternatively, each component carrier 210 may be used to communicate uplink communications, downlink communications, or both, and the UE 115-a may measure an uplink active use duration, a downlink active use duration, or both for each component carrier 210. The uplink active use duration for a component carrier 210 may include a combined duration during which the UE 115-a actively transmits signaling to the network entity 105-a via the component carrier 210, and the downlink active use duration for the component carrier 210 may include a combined duration during which the UE 115-a actively receives signaling from the network entity 105-a via the component carrier 210.

Accordingly, each component carrier 210 may be associated with an active use duration (e.g., an uplink active use duration, a downlink active use duration, or both), and the UE 115-a may select a set of component carriers 215 from the multiple component carriers 210 based on the respective active use duration of each component carrier 210 in the set exceeding a threshold duration. The threshold duration may be a threshold for inclusion of respective component carriers 210 in the set of component carriers 215 selected by the UE 115-a, and may be a quantity of milliseconds, or may be a percentage of the observation window (e.g., 50 percent of the observation window), or the like. In some cases, the threshold duration may be a threshold for inclusion of respective component carriers 210 in a set of candidate uplink component carriers 215-a, while a second threshold duration may be a threshold for inclusion of respective component carriers in a second set of candidate downlink component carriers 215-b. The threshold duration may be the same as or different than the second threshold duration, and the UE 115-a may select respective component carriers 210 for inclusion in the set of candidate uplink component carriers 215-a and the set of candidate downlink component carriers 215-b based on the corresponding threshold duration for the set. Additionally, or alternatively, there may be a single threshold duration associated with a single set of candidate component carriers that includes both uplink and downlink component carriers 210. The threshold durations may be configured at the UE 115-a, indicated to the UE 115-a via control signaling (e.g., RRC), or the like.

In the example of FIG. 2, the UE 115-a may measure an uplink active use duration for a component carrier 210-a as the percentage of the observation window during which the UE 115-a actively exchanges uplink signaling via component carrier 210-a. The UE 115-a may additionally measure a downlink active use duration for the component carrier 210-a as the percentage of the observation window during which the UE 115-a actively exchanges downlink signaling via component carrier 210-a. The UE 115-a may select the component carrier 210-a for inclusion in the set of candidate uplink component carriers 215-a based on the uplink active use duration exceeding the threshold for inclusion in the set of candidate uplink component carriers 215-a. In the example of FIG. 2, a downlink active use duration for the component carrier 210-a may be less than a corresponding downlink threshold for inclusion in the set of candidate downlink component carriers 215-b, and the UE 115-a may exclude the component carrier 210-a from the set of candidate downlink component carriers 215-b accordingly. The UE 115-a may perform similar measurements of the active use durations (e.g., the uplink active use duration, the downlink active use duration, a combined active use duration for uplink and downlink, or any combination thereof) of each of the component carriers 210, and may select a set of candidate uplink component carriers 215-a and a set of candidate downlink component carriers 215-b accordingly.

In some cases, the set of candidate uplink component carriers 215-a may include a different quantity of component carriers 210, a different combination of component carriers 210, or both, than the set of candidate downlink component carriers 215-b. For example, with reference to FIG. 2, the UE 115-a may select two component carriers 210 (e.g., the component carriers 210-a and 210-b) for inclusion in the set of candidate uplink component carriers 215-a, and the UE 115-a may select three component carriers 210 (e.g., the component carriers 210-b, 210-c, and 210-d) for inclusion in the set of candidate downlink component carriers 215-b. The set of candidate uplink component carriers 215-a may include one or more component carriers 210 that are not included in the set of candidate downlink component carriers 215-b. For example, the set of candidate uplink component carriers 215-a may include the component carrier 210-a, which may not be included in the set of candidate downlink component carriers 215-b. Some component carriers 210, such as the component carrier 210-b, may be included in both sets. The component carrier 210-e may not be included in either sets of component carriers 215 based on the active use duration of component carrier 210-e (e.g., a combined active use duration, or both the uplink and downlink active use durations) being below the threshold duration. Thus, the UE 115-a may limit the sets of candidate component carriers 215 to component carriers 210 that are actively used for either uplink communications, downlink communications, or both.

The UE 115-a may receive reference signals 220 via any of the component carriers 210 indicated via the component carrier configuration from the network entity 105-a. However, the UE 115-a may restrict measurements of reference signals 220 for beam selection to measurements of reference signals 220 received via the sets of candidate component carriers 215 selected from the multiple component carriers 210 configured by the network entity 105-a. The UE 115-a may measure the received reference signals 220 via the sets of candidate component carriers 215 in order to perform beam selection.

For example, as illustrated by FIG. 2, the UE 115-a may receive one or more reference signals 220 via the component carriers 210-a and 210-b included in the set of candidate uplink component carriers 215-a and via the component carriers 210-b, 210-c, and 210-d included in the set of candidate downlink component carriers 215-b. The UE 115-a may not receive reference signals 220 via the component carrier 210-e. Additionally, or alternatively, the UE 115-a may receive a reference signal 220 via the component carrier 210-e, but the UE 115-a may refrain from measuring the reference signal for beam selection because the component carrier 210-e is excluded from a set of candidate component carriers 215 for beam selection. The reference signals 220 received via the set of candidate uplink component carriers 215-a may be the same as or different than the reference signals 220 received via the set of candidate downlink component carriers 215-b.

Each reference signal 220 may be associated with a candidate beam 225 supported by the UE 115-a (e.g., and an associated transmission configuration indicator (TCI) state). The UE 115-a may measure respective values of one or more metrics (e.g., signal-to-noise ratio (SNR) signal-to-interference-plus-noise ratio (SINR), reference signal received power (RSRP), reference signal received quality (RSRQ), CSI, or any combination thereof) associated with each reference signal 220 received via the set of candidate uplink component carriers 215-a and the set of candidate downlink component carriers 215-b. The UE 115-a may select a beam from the multiple candidate beams 225, including beams 225-a, 225-b, and 225-c (among other beams 225 not pictured in FIG. 2) supported by the UE 115-a based on measuring each reference signal 220. The selected beam may be an uplink beam, a downlink beam, or both, and may be associated with a reference signal 220 that has a value of the metric that satisfies one or more beam selection conditions.

In some cases, the UE 115-a may select a beam from among the candidate beams 225 and use the selected beam to communicate uplink communications, downlink communications, or both. The UE 115-a may select the beam associated with a reference signal 220 that has a value of the metric that satisfies one or more beam selection conditions associated with both uplink and downlink communications at the UE 115-a. In other cases, the UE 115-a may select an uplink beam and a downlink beam, which may be separate beams selected based on measuring reference signals 220 received via the set of candidate uplink component carriers 215-a and the set of candidate downlink component carriers 215-b, respectively. In such cases, the UE 115-a may use different metrics, threshold durations, or both to select the uplink beam and the downlink beam. For example, the UE 115-a may select an uplink beam associated with a reference signal 220 that has a value of a metric that satisfies on or more beam selection conditions for uplink communications. The UE 115-a may additionally, or alternatively, select a downlink beam associated with a reference signal 220 that has a value of a different metric that satisfies one or more beam selection conditions for downlink communications. Similarly, the UE 115-a may select an uplink beam and a downlink beam using different threshold durations for inclusion of component carriers 210 in the set of candidate uplink component carriers 215-a and the set of candidate downlink component carriers 215-b. The UE 115-a may communicate using the selected beam (e.g., the uplink beam and the selected downlink beam.

Accordingly, the UE 115-a may limit reference signal measurements for beam selection to measurements of reference signals and corresponding beams received via a set of component carriers 215 via which the UE 115 actively communicates. The UE 115-a may select a set of component carriers 215 from among the component carriers 210 configured by the network entity 105-a, which may be a set of uplink component carriers 215-a, a set of downlink component carriers 215-b, or both. The UE 115-a may limit reference signal measurements to reference signals 220 received via the set(s) of component carriers 215, and may select a beam (e.g., and uplink beam, a downlink beam, or both) associated with a reference signal that has a value of the metric that satisfies one or more beam selection conditions. Thus, the UE 115-a may reduce the quantity of component carriers 210 considered during multi-component carrier beam selection to reduce latency and overhead, among other examples.

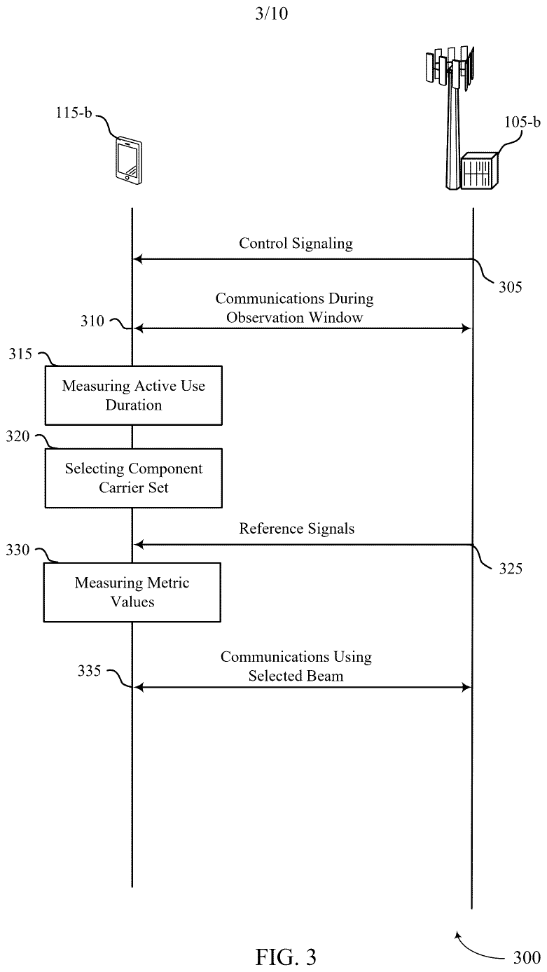

FIG. 3 shows an example process flow 300 that supports uplink and downlink beam selection with specific component carrier constraint in accordance with one or more aspects of the present disclosure. The process flow 300 may implement aspects of or may be implemented by aspects of the wireless communications system 100 or the wireless communication system 200. For example, the process flow 300 may include a UE 115-b and a network entity 105-b, which may be examples of the corresponding devices as described with reference to FIG. 1.

In the following description of the process flow 300, the operations between the UE 115-b and the network entity 105-b may be transmitted in a different order than the example order shown. Some operations may also be omitted from the process flow 300, and other operations may be added to the process flow 300. Further, although some operations or signaling may be shown to occur at different times for discussion purposes, these operations may actually occur at the same time.

At 305, the network entity 105-b may transmit control signaling to the UE 115-b indicating a configuration of component carriers for communications by the UE 115-b. The component carriers may include a PCC in addition to one or more SCCs that the UE 115-b may use during a multi-component carrier beam selection scenario, among other example combinations of component carrier types. The network entity 105-b may configure one or more uplink component carriers, one or more downlink component carriers, or both, as indicated by the component carrier configuration.

At 310, in some examples, the UE 115-b may communicate with the network entity 105-b via the component carriers during an observation window, which may be associated with respective duration (e.g., 10 ms, 20 ms, 30 ms). During the observation window, the UE 115-b may actively exchange uplink signaling, downlink signaling, or both, with the network entity 105-b via each component carrier of the configured component carriers for respective durations (e.g., 3 ms, 5 ms, 10 ms). For example, the duration of the observation window may be 20 ms, and the UE 115-b may communicate uplink signaling via one of the component carriers for a duration of 3 ms during the 20 ms duration of the observation window, and the network entity 105-b may communicate downlink signaling via the same component carrier for a duration of 10 ms of the 20 ms observation window, or some other example durations. In some cases, the UE 115-b and the network entity 105-b may not actively exchange signaling via all of the component carriers of the configured component during the observation window.

At 315, in some examples, the UE 115-b may measure a respective active use duration for each component carrier configured by the network entity 105-b via the control signaling at 305. An active use duration for a component carrier may be a duration over which the UE 115-b actively communicates via the component carrier within the observation window, and may be a respective uplink active use duration or a respective downlink active use duration, or both (e.g., duration for combined uplink and downlink use). For instance, the UE 115-b may measure the respective uplink active use duration and the respective downlink active use duration for the component carrier as a respective duration over which the UE 115-b actively exchanges uplink signaling or downlink signaling via the component carrier, respectively. The respective active uplink use duration for the component carrier may be a ratio between the respective duration over which the UE 115-b actively exchanges uplink signaling via the component carrier and the duration of the observation window. Similarly, the respective active downlink use duration for the component carrier may be a ratio between the respective duration over which the UE 115-b actively exchanges downlink signaling via the component carrier and the duration of the observation window. In some other examples, the UE 115-b may measure a combined (e.g., cumulative) active use duration for the component carrier, which includes the durations for which the UE 115-b actively exchanges uplink and downlink signaling with the network entity 105-b.

At 320, in some examples, the UE 115-b may select a set of component carriers from among the component carriers configured by the network entity 105-b based on the respective active use duration for each component carrier of the set exceeding a threshold duration. In some cases, the UE 115-b may select a set of uplink candidate component carriers based on the active use duration (e.g., the uplink active use duration or the combined active use duration) of each component carrier in the set exceeding a threshold duration. The UE 115-b may alternatively select a set of candidate downlink component carriers based on the active use duration (e.g., the downlink active use duration or the combined active use duration) of each component carrier in the set exceeding a threshold duration, which may be the same as or different than the threshold duration used to select the set of candidate uplink component carriers. In some other cases, the UE 115-a may select two separate sets of candidate component carriers, including a set of candidate uplink component carriers and a set of candidate downlink component carriers.

At 325, the UE 115-b may receive reference signals from the network entity 105-b. The reference signals may be examples of the reference signals 220 in FIG. 2, and may be transmitted periodically or intermittently. The UE 115-b may receive the reference signals concurrently with or interleaved in time with other communications transmitted and received by the UE 115-b. The reference signals may be received at the UE 115-b via the set of component carriers, and each reference signal may be associated with a candidate beam of multiple candidate uplink beams supported by the UE 115-b. Each reference signal may be associated with one or more metrics (e.g., SINR, RSRP, RSRQ, CSI, or any combination thereof) relevant to one or more beam selection conditions. The UE 115-b may reduce a quantity of candidate component carriers considered during multi-component carrier beam selection by limiting reference signal measurement to reference signals received via the component carriers included in the set of component carriers. The UE 115-b may ignore reference signals received via component carriers not included in the set of component carriers when performing beam selection.

At 330, the UE 115-b may measure the respective values of the metric associated with each reference signal of reference signals received via the set of component carriers. For instance, the UE 115-b may measure the respective RSRP values for each reference signal of the first set of reference signals. Each reference signal may have a different value of the metric for each component carrier of the set of candidate uplink component carriers via which the reference signal is received.

At 335, the UE 115-b may communicate with the network entity 105-b using a beam that is selected from the multiple candidate beams supported by the UE 115-b. The UE 115-b may select the beam based on the measuring the reference signals received at 325, where the selected beam is associated with a reference signal that has a value of the metric that satisfies one or more beam selection conditions. In some cases, the UE 115-b may select either an uplink beam or a downlink beam to be used to communicate uplink communications or downlink communications with the network entity 105-b, respectively. Alternatively, the UE 115-b may select both an uplink beam and a downlink beam, which may be different beams or the same beam from among the multiple candidate beams supported by the UE 115-b. The selected beam (e.g., the uplink beam, the downlink beam, or both) may be associated with a reference signal that has a value of the metric that satisfies the one or more beam selection conditions.

In some cases, each reference signal received at 325 may have a different value of the metric for each component carrier of the set of component carriers via which the reference signal is received. The UE 115-b may select the beam associated with the reference signal that has a value of the metric that satisfies one or more beam selection conditions, where the value of the reference signal is specific to a component carrier of the set of component carriers. In some other cases, the UE 115-b may select the beam based on an average value of the metric across the reference signals received at 325 satisfying one or more beam selection conditions. For instance, each reference signal received at 325 may be associated with an average value of the metric, where the average value of the metric may be obtained (e.g., calculated, estimated) by averaging the value of the metric associated with each reference signal across the component carriers in the set of component carriers. The UE 115-b may select the beam that is associated with a reference signal that has an average value of the metric that satisfies one or more beam selection conditions. In some examples, the conditions for selection of an uplink beam may be the same as or different than the conditions for selection of a downlink beam. In some examples, the UE 115-b may select a single beam that may be applied to both uplink and downlink communications.

The UE 115-b as described herein may thereby use an active use duration to select a candidate set of component carriers from among multiple configured component carriers. The UE 115-b may use measurements of reference signals received via the reduced candidate set of component carriers to perform beam selection instead of using measurements across all component carriers, which may reduce latency, processing, and overhead, while maintaining or otherwise improving communication reliability and performance of the UE 115-b, among other examples.

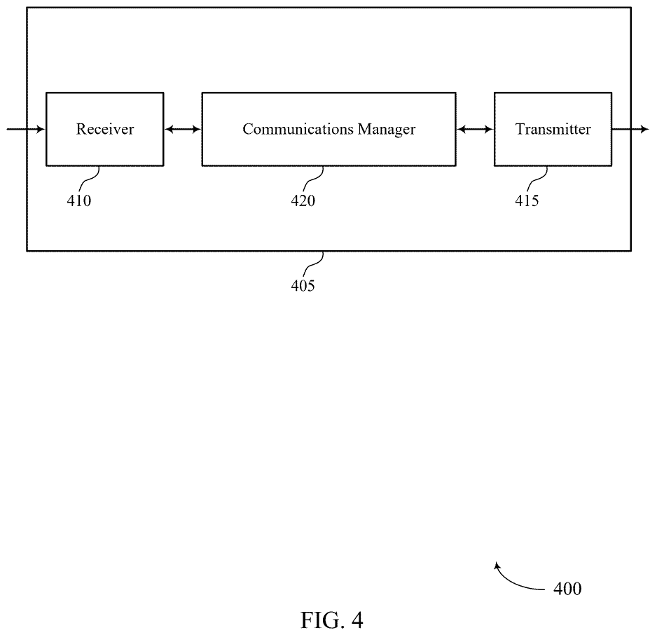

FIG. 4 shows a block diagram 400 of a device 405 that supports enhanced uplink and downlink beam selection using candidate component carrier reduction in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to enhanced uplink and downlink beam selection using candidate component carrier reduction). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to enhanced uplink and downlink beam selection using candidate component carrier reduction). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of enhanced uplink and downlink beam selection using candidate component carrier reduction as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving control signaling that indicates a set of multiple component carriers for communications by the UE. The communications manager 420 is capable of, configured to, or operable to support a means for receiving one or more reference signals via a set of component carriers, where the set of component carriers includes one or more component carriers, of the set of multiple component carriers indicated via the control signaling, that are associated with an active use duration that is greater than a threshold duration, where the active use duration for a component carrier includes a combined duration over which the UE actively communicates via the component carrier during an observation window. The communications manager 420 is capable of, configured to, or operable to support a means for communicating using a beam that is selected from a set of multiple candidate beams supported by the UE based on measurements of the one or more reference signals, where the beam is associated with a reference signal, of the one or more reference signals, having a metric that satisfies one or more beam selection conditions.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reducing latency and overhead associated with multi-component carrier beam selection.

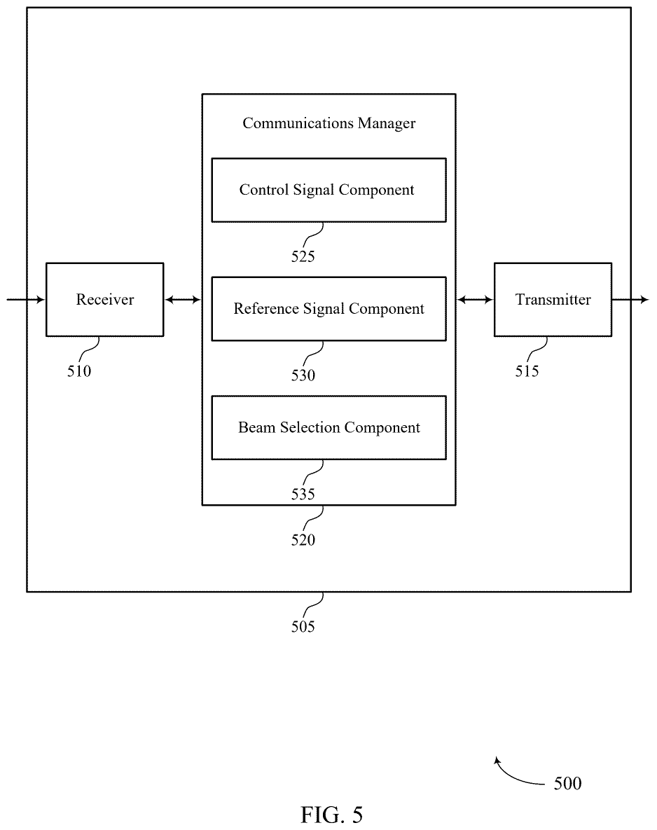

FIG. 5 shows a block diagram 500 of a device 505 that supports enhanced uplink and downlink beam selection using candidate component carrier reduction in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to enhanced uplink and downlink beam selection using candidate component carrier reduction). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to enhanced uplink and downlink beam selection using candidate component carrier reduction). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of enhanced uplink and downlink beam selection using candidate component carrier reduction as described herein. For example, the communications manager 520 may include a control signal component 525, a reference signal component 530, a beam selection component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The control signal component 525 is capable of, configured to, or operable to support a means for receiving control signaling that indicates a set of multiple component carriers for communications by the UE. The reference signal component 530 is capable of, configured to, or operable to support a means for receiving one or more reference signals via a set of component carriers, where the set of component carriers includes one or more component carriers, of the set of multiple component carriers indicated via the control signaling, that are associated with an active use duration that is greater than a threshold duration, where the active use duration for a component carrier includes a combined duration over which the UE actively communicates via the component carrier during an observation window. The beam selection component 535 is capable of, configured to, or operable to support a means for communicating using a beam that is selected from a set of multiple candidate beams supported by the UE based on measurements of the one or more reference signals, where the beam is associated with a reference signal, of the one or more reference signals, having a metric that satisfies one or more beam selection conditions.

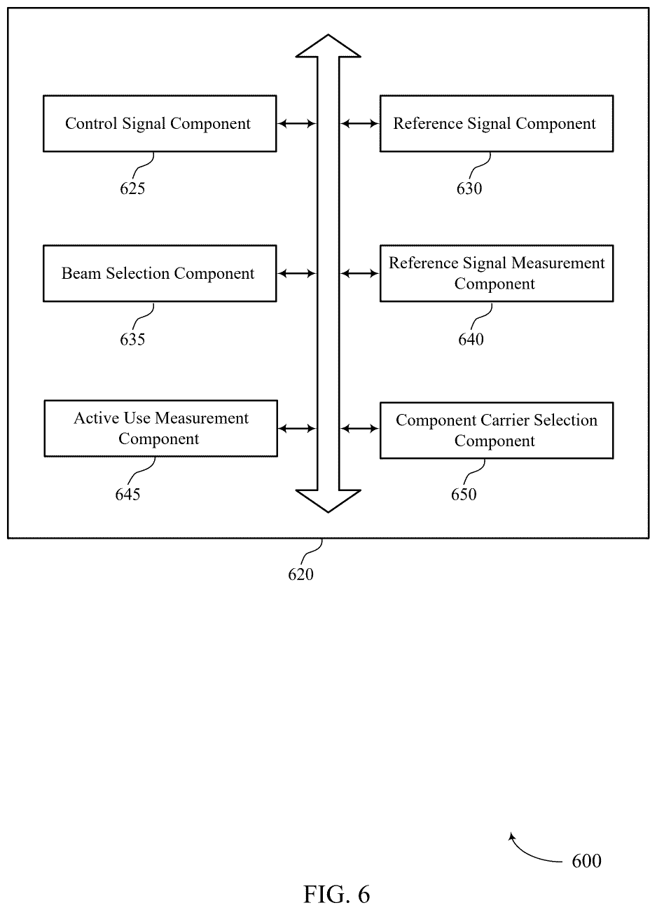

FIG. 6 shows a block diagram 600 of a communications manager 620 that supports enhanced uplink and downlink beam selection using candidate component carrier reduction in accordance with one or more aspects of the present disclosure. The communications manager 620 may be an example of aspects of a communications manager 420, a communications manager 520, or both, as described herein. The communications manager 620, or various components thereof, may be an example of means for performing various aspects of enhanced uplink and downlink beam selection using candidate component carrier reduction as described herein. For example, the communications manager 620 may include a control signal component 625, a reference signal component 630, a beam selection component 635, a reference signal measurement component 640, an active use measurement component 645, a component carrier selection component 650, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The control signal component 625 is capable of, configured to, or operable to support a means for receiving control signaling that indicates a set of multiple component carriers for communications by the UE. The reference signal component 630 is capable of, configured to, or operable to support a means for receiving one or more reference signals via a set of component carriers, where the set of component carriers includes one or more component carriers, of the set of multiple component carriers indicated via the control signaling, that are associated with an active use duration that is greater than a threshold duration, where the active use duration for a component carrier includes a combined duration over which the UE actively communicates via the component carrier during an observation window. The beam selection component 635 is capable of, configured to, or operable to support a means for communicating using a beam that is selected from a set of multiple candidate beams supported by the UE based on measurements of the one or more reference signals, where the beam is associated with a reference signal, of the one or more reference signals, having a metric that satisfies one or more beam selection conditions.

In some examples, the reference signal component 630 is capable of, configured to, or operable to support a means for receiving one or more second reference signals via a second set of component carriers, where the second set of component carriers includes one or more downlink component carriers, of the set of multiple component carriers indicated via the control signaling, that are associated with respective second active use durations that are greater than a second threshold duration, and where the set of component carriers includes one or more uplink component carriers.

In some examples, the set of component carriers includes a first quantity of component carriers that is different from a second quantity of component carriers included in the second set of component carriers. In some examples, the set of component carriers includes at least one component carrier that is not included in the second set of component carriers, the second set of component carriers includes at least one component carrier that is not included in the set of component carriers, or both.

In some examples, the beam selection component 635 is capable of, configured to, or operable to support a means for communicating using a second beam that is selected from the set of multiple candidate beams supported by the UE based on second measurements of the one or more second reference signals, where the second beam includes a downlink beam associated with a second reference signal, of the one or more second reference signals, having a second metric that satisfies the one or more beam selection conditions, and where the beam includes an uplink beam.

In some examples, a second metric of a second reference signal for selection of a second beam of the set of multiple candidate beams is different from the metric of the reference signal associated with the beam and used for selection of the beam based on the beam including an uplink beam and the second beam including a downlink beam.

In some examples, the reference signal measurement component 640 is capable of, configured to, or operable to support a means for measuring respective values of the metric associated with each reference signal of the one or more reference signals. In some examples, the beam selection component 635 is capable of, configured to, or operable to support a means for selecting the beam from the set of multiple candidate beams based on a value of the metric associated with the reference signal satisfying the one or more beam selection conditions, where communicating using the beam is based on selecting the beam.

In some examples, the reference signal measurement component 640 is capable of, configured to, or operable to support a means for measuring respective values of the metric associated with each reference signal of the one or more reference signals. In some examples, the beam selection component 635 is capable of, configured to, or operable to support a means for selecting the beam from the set of multiple candidate beams based on an average value of the metric across the one or more reference signals satisfying the one or more beam selection conditions, where communicating using the beam is based on selecting the beam.

In some examples, the beam selection component 635 is capable of, configured to, or operable to support a means for communicating via the set of multiple component carriers during the observation window. In some examples, the active use measurement component 645 is capable of, configured to, or operable to support a means for measuring, for each component carrier of the set of multiple component carriers based on communicating during the observation window, a respective active use duration for each component. In some examples, the component carrier selection component 650 is capable of, configured to, or operable to support a means for selecting the set of component carriers from among the set of multiple component carriers based on the respective active use durations for each component carrier of the set of component carriers exceeding the threshold duration, where receiving the one or more reference signals via the set of component carriers is based on the selecting.

In some examples, to support measuring the respective duration over which the UE actively exchanges signaling via the component carrier, the active use measurement component 645 is capable of, configured to, or operable to support a means for measuring, for each component carrier of the set of multiple component carriers, a first respective duration over which the UE actively exchanges uplink signaling via the component carrier while communicating during the observation window, where a respective uplink active use duration is based on the first respective duration. In some examples, to support measuring the respective duration over which the UE actively exchanges signaling via the component carrier, the active use measurement component 645 is capable of, configured to, or operable to support a means for measuring, for each component carrier of the set of multiple component carriers, a second respective duration over which the UE actively exchanges downlink signaling via the component carrier while communicating during the observation window, where a respective downlink active use duration is based at least on part on the second respective duration.

In some examples, the threshold duration includes a first threshold for inclusion of respective component carriers in the set of component carriers. In some examples, a second threshold duration includes a second threshold for inclusion of respective component carriers in a second set of component carriers.

In some examples, the respective active use duration for the component carrier includes a ratio between the respective duration over which the UE actively exchanges signaling via the component carrier and a second duration of the observation window.

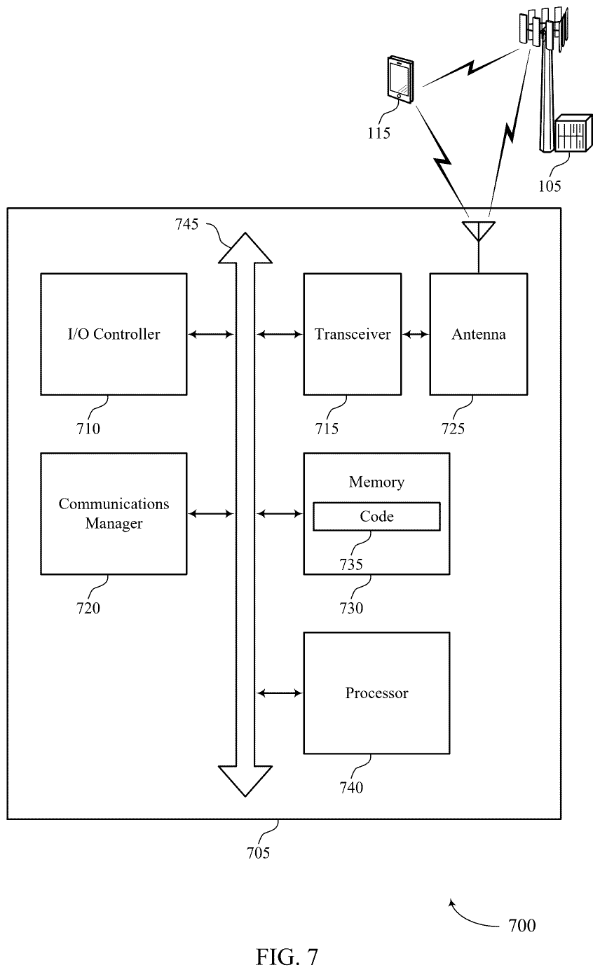

FIG. 7 shows a diagram of a system 700 including a device 705 that supports enhanced uplink and downlink beam selection using candidate component carrier reduction in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting enhanced uplink and downlink beam selection using candidate component carrier reduction). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving control signaling that indicates a set of multiple component carriers for communications by the UE. The communications manager 720 is capable of, configured to, or operable to support a means for receiving one or more reference signals via a set of component carriers, where the set of component carriers includes one or more component carriers, of the set of multiple component carriers indicated via the control signaling, that are associated with an active use duration that is greater than a threshold duration, where the active use duration for a component carrier includes a combined duration over which the UE actively communicates via the component carrier during an observation window. The communications manager 720 is capable of, configured to, or operable to support a means for communicating using a beam that is selected from a set of multiple candidate beams supported by the UE based on measurements of the one or more reference signals, where the beam is associated with a reference signal, of the one or more reference signals, having a metric that satisfies one or more beam selection conditions.

By including or configuring the communications manager 720 in accordance with examples as described herein, the device 705 may support techniques for reducing latency and overhead associated with multi-component carrier beam selection.

In some examples, the communications manager 720 may be configured to perform various operations (e.g., receiving, monitoring, transmitting) using or otherwise in cooperation with the transceiver 715, the one or more antennas 725, or any combination thereof. For example, the communications manager 720 may be configured to receive or transmit messages or other signaling as described herein via the transceiver 715. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of enhanced uplink and downlink beam selection using candidate component carrier reduction as described herein, or the at least one processor 740 and the at least one memory 730 may be otherwise configured to, individually or collectively, perform or support such operations.

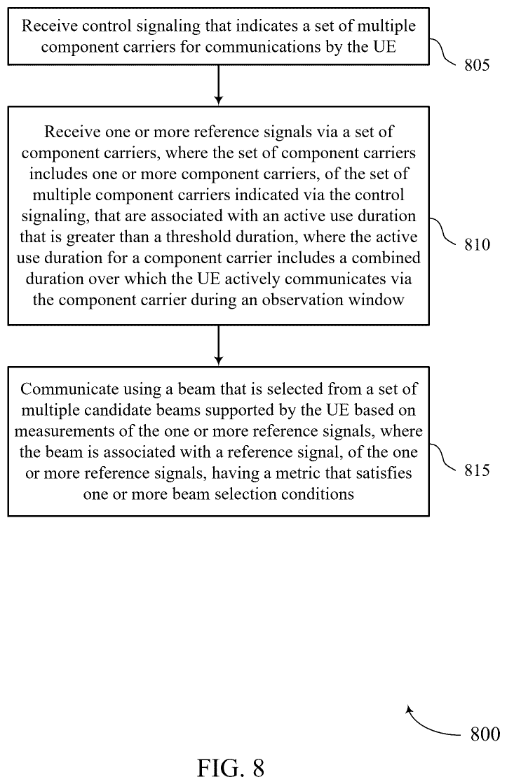

FIG. 8 shows a flowchart illustrating a method 800 that supports enhanced uplink and downlink beam selection using candidate component carrier reduction in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include receiving control signaling that indicates a set of multiple component carriers for communications by the UE. The operations of 805 may be performed in accordance with examples as disclosed herein. In some examples, aspects of the operations of 805 may be performed by a control signal component 625 as described with reference to FIG. 6. Additionally, or alternatively, means for performing 805 may, but not necessarily, include, for example, antenna 725, transceiver 715, communications manager 720, memory 730 (including code 735), processor 740, and/or bus 745.

At 810, the method may include receiving one or more reference signals via a set of component carriers, where the set of component carriers includes one or more component carriers, of the set of multiple component carriers indicated via the control signaling, that are associated with an active use duration that is greater than a threshold duration, where the active use duration for a component carrier includes a combined duration over which the UE actively communicates via the component carrier during an observation window. The operations of 810 may be performed in accordance with examples as disclosed herein. In some examples, aspects of the operations of 810 may be performed by a reference signal component 630 as described with reference to FIG. 6. Additionally, or alternatively, means for performing 810 may, but not necessarily, include, for example, antenna 725, transceiver 715, communications manager 720, memory 730 (including code 735), processor 740, and/or bus 745.

At 815, the method may include communicating using a beam that is selected from a set of multiple candidate beams supported by the UE based on measurements of the one or more reference signals, where the beam is associated with a reference signal, of the one or more reference signals, having a metric that satisfies one or more beam selection conditions. The operations of 815 may be performed in accordance with examples as disclosed herein. In some examples, aspects of the operations of 815 may be performed by a beam selection component 635 as described with reference to FIG. 6. Additionally, or alternatively, means for performing 815 may, but not necessarily, include, for example, antenna 725, transceiver 715, communications manager 720, memory 730 (including code 735), processor 740, and/or bus 745.

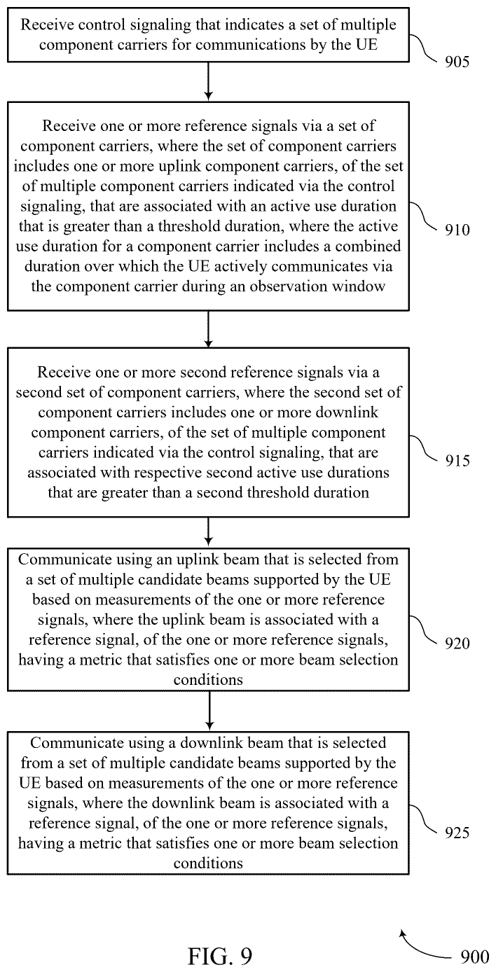

FIG. 9 shows a flowchart illustrating a method 900 that supports enhanced uplink and downlink beam selection using candidate component carrier reduction in accordance with one or more aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 905, the method may include receiving control signaling that indicates a set of multiple component carriers for communications by the UE. The operations of 905 may be performed in accordance with examples as disclosed herein. In some examples, aspects of the operations of 905 may be performed by a control signal component 625 as described with reference to FIG. 6. Additionally, or alternatively, means for performing 905 may, but not necessarily, include, for example, antenna 725, transceiver 715, communications manager 720, memory 730 (including code 735), processor 740, and/or bus 745.

At 910, the method may include receiving one or more reference signals via a set of component carriers, where the set of component carriers includes one or more component carriers, of the set of multiple component carriers indicated via the control signaling, that are associated with an active use duration that is greater than a threshold duration, where the active use duration for a component carrier includes a combined duration over which the UE actively communicates via the component carrier during an observation window. The operations of 910 may be performed in accordance with examples as disclosed herein. In some examples, aspects of the operations of 910 may be performed by a reference signal component 630 as described with reference to FIG. 6. Additionally, or alternatively, means for performing 910 may, but not necessarily, include, for example, antenna 725, transceiver 715, communications manager 720, memory 730 (including code 735), processor 740, and/or bus 745.

At 915, the method may include receiving one or more second reference signals via a second set of component carriers, where the second set of component carriers includes one or more downlink component carriers, of the set of multiple component carriers indicated via the control signaling, that are associated with respective second active use durations that are greater than a second threshold duration, and where the set of component carriers includes one or more uplink component carriers. The operations of 915 may be performed in accordance with examples as disclosed herein. In some examples, aspects of the operations of 915 may be performed by a reference signal component 630 as described with reference to FIG. 6. Additionally, or alternatively, means for performing 915 may, but not necessarily, include, for example, antenna 725, transceiver 715, communications manager 720, memory 730 (including code 735), processor 740, and/or bus 745

At 920, the method may include communicating using an uplink beam that is selected from a set of multiple candidate beams supported by the UE based on measurements of the one or more reference signals, where the uplink beam is associated with a reference signal, of the one or more reference signals, having a metric that satisfies one or more beam selection conditions. The operations of 920 may be performed in accordance with examples as disclosed herein. In some examples, aspects of the operations of 920 may be performed by a beam selection component 635 as described with reference to FIG. 6. Additionally, or alternatively, means for performing 920 may, but not necessarily, include, for example, antenna 725, transceiver 715, communications manager 720, memory 730 (including code 735), processor 740, and/or bus 745.

At 925, the method may include communicating using a downlink beam that is selected from a set of multiple candidate beams supported by the UE based on measurements of the one or more reference signals, where the downlink beam is associated with a reference signal, of the one or more reference signals, having a metric that satisfies one or more beam selection conditions. The operations of 925 may be performed in accordance with examples as disclosed herein. In some examples, aspects of the operations of 925 may be performed by a beam selection component 635 as described with reference to FIG. 6. Additionally, or alternatively, means for performing 920 may, but not necessarily, include, for example, antenna 725, transceiver 715, communications manager 720, memory 730 (including code 735), processor 740, and/or bus 745.

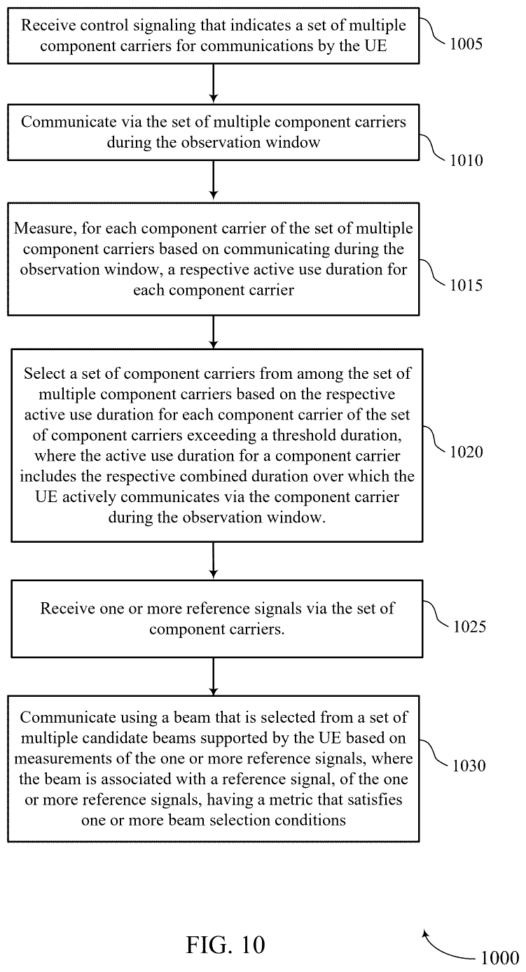

FIG. 10 shows a flowchart illustrating a method 1000 that supports enhanced uplink and downlink beam selection using candidate component carrier reduction in accordance with one or more aspects of the present disclosure. The operations of the method 1000 may be implemented by a UE or its components as described herein. For example, the operations of the method 1000 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1005, the method may include receiving control signaling that indicates a set of multiple component carriers for communications by the UE. The operations of 1005 may be performed in accordance with examples as disclosed herein. In some examples, aspects of the operations of 1005 may be performed by a control signal component 625 as described with reference to FIG. 6. Additionally, or alternatively, means for performing 1005 may, but not necessarily, include, for example, antenna 725, transceiver 715, communications manager 720, memory 730 (including code 735), processor 740, and/or bus 745.

At 1010, the method may include communicating via the set of multiple component carriers during the observation window. The operations of 1010 may be performed in accordance with examples as disclosed herein. In some examples, aspects of the operations of 1010 may be performed by a beam selection component 635 as described with reference to FIG. 6. Additionally, or alternatively, means for performing 1010 may, but not necessarily, include, for example, antenna 725, transceiver 715, communications manager 720, memory 730 (including code 735), processor 740, and/or bus 745.

At 1015, the method may include measuring, for each component carrier of the set of multiple component carriers based on communicating during the observation window, a respective active use duration for each component. The operations of 1015 may be performed in accordance with examples as disclosed herein. In some examples, aspects of the operations of 1015 may be performed by an active use measurement component 645 as described with reference to FIG. 6. Additionally, or alternatively, means for performing 1015 may, but not necessarily, include, for example, antenna 725, transceiver 715, communications manager 720, memory 730 (including code 735), processor 740, and/or bus 745.

At 1020, the method may include selecting the set of component carriers from among the set of multiple component carriers based on the respective active use duration for each component carrier of the set of component carriers exceeding a threshold duration, where the active use duration for a component carrier includes the respective combined duration over which the UE actively communicates via the component carrier during the observation window. The operations of 1020 may be performed in accordance with examples as disclosed herein. In some examples, aspects of the operations of 1020 may be performed by a component carrier selection component 650 as described with reference to FIG. 6. Additionally, or alternatively, means for performing 1020 may, but not necessarily, include, for example, antenna 725, transceiver 715, communications manager 720, memory 730 (including code 735), processor 740, and/or bus 745.

At 1025, the method may include receiving one or more reference signals via the set of component carriers. The operations of 1025 may be performed in accordance with examples as disclosed herein. In some examples, aspects of the operations of 1025 may be performed by a reference signal component 630 as described with reference to FIG. 6. Additionally, or alternatively, means for performing 1025 may, but not necessarily, include, for example, antenna 725, transceiver 715, communications manager 720, memory 730 (including code 735), processor 740, and/or bus 745.

At 1030, the method may include communicating using a beam that is selected from a set of multiple candidate beams supported by the UE based on measurements of the one or more reference signals, where the beam is associated with a reference signal, of the one or more reference signals, having a metric that satisfies one or more beam selection conditions. The operations of 1030 may be performed in accordance with examples as disclosed herein. In some examples, aspects of the operations of 1030 may be performed by a beam selection component 635 as described with reference to FIG. 6. Additionally, or alternatively, means for performing 1030 may, but not necessarily, include, for example, antenna 725, transceiver 715, communications manager 720, memory 730 (including code 735), processor 740, and/or bus 745.

The following provides an overview of aspects of the present disclosure:

Aspect 1: A method for wireless communications at a UE, comprising: receiving control signaling that indicates a plurality of component carriers for communications by the UE; receiving one or more reference signals via a set of component carriers, wherein the set of component carriers comprises one or more component carriers, of the plurality of component carriers indicated via the control signaling, that are associated with an active use duration that is greater than a threshold duration, wherein the active use duration for a component carrier comprises a combined duration over which the UE actively communicates via the component carrier during an observation window; and communicating using a beam that is selected from a plurality of candidate beams supported by the UE based at least in part on measurements of the one or more reference signals, wherein the beam is associated with a reference signal, of the one or more reference signals, having a metric that satisfies one or more beam selection conditions.

Aspect 2: The method of aspect 1, further comprising: receiving one or more second reference signals via a second set of component carriers, wherein the second set of component carriers comprises one or more downlink component carriers, of the plurality of component carriers indicated via the control signaling, that are associated with respective second active use durations that are greater than a second threshold duration, and wherein the set of component carriers comprises one or more uplink component carriers.

Aspect 3: The method of aspect 2, wherein the set of component carriers comprises a first quantity of component carriers that is different from a second quantity of component carriers included in the second set of component carriers; and the set of component carriers comprises at least one component carrier that is not included in the second set of component carriers, the second set of component carriers comprises at least one component carrier that is not included in the set of component carriers, or both.

Aspect 4: The method of any of aspects 2 through 3, further comprising: communicating using a second beam that is selected from the plurality of candidate beams supported by the UE based at least in part on second measurements of the one or more second reference signals, wherein the second beam comprises a downlink beam associated with a second reference signal, of the one or more second reference signals, having a second metric that satisfies the one or more beam selection conditions, and wherein the beam comprises an uplink beam.

Aspect 5: The method of any of aspects 2 through 4, wherein a second metric of a second reference signal for selection of a second beam of the plurality of candidate beams is different from the metric of the reference signal associated with the beam and used for selection of the beam based at least in part on the beam comprising an uplink beam and the second beam comprising a downlink beam.

Aspect 6: The method of any of aspects 1 through 5, further comprising: measuring respective values of the metric associated with each reference signal of the one or more reference signals; and selecting the beam from the plurality of candidate beams based at least in part on a value of the metric associated with the reference signal satisfying the one or more beam selection conditions, wherein communicating using the beam is based at least in part on selecting the beam.

Aspect 7: The method of any of aspects 1 through 5, further comprising: measuring respective values of the metric associated with each reference signal of the one or more reference signals; and selecting the beam from the plurality of candidate beams based at least in part on an average value of the metric across the one or more reference signals satisfying the one or more beam selection conditions, wherein communicating using the beam is based at least in part on selecting the beam.

Aspect 8: The method of any of aspects 1 through 5, further comprising: communicating via the plurality of component carriers during the observation window; measuring, for each component carrier of the plurality of component carriers based at least in part on communicating during the observation window, a respective active use duration for each component carrier and selecting the set of component carriers from among the plurality of component carriers based at least in part on the respective active use durations for each component carrier of the set of component carriers exceeding the threshold duration, wherein receiving the one or more reference signals via the set of component carriers is based at least in part on the selecting.

Aspect 9: The method of aspect 8, wherein measuring the respective active use duration for each component carrier further comprises: measuring, for each component carrier of the plurality of component carriers, a first respective active use duration over which the UE actively exchanges uplink signaling via the component carrier while communicating during the observation window, wherein a respective uplink active use duration is based at least in part on the first respective active use duration; and measuring, for each component carrier of the plurality of component carriers, a second respective active use duration over which the UE actively exchanges downlink signaling via the component carrier while communicating during the observation window, wherein a respective downlink active use duration is based at least on part on the second respective active use duration.

Aspect 10: The method of aspect 9, wherein: the threshold duration comprises a threshold for inclusion of respective component carriers in the set of component carriers, and a second threshold duration comprises a threshold for inclusion of respective component carriers in a second set of component.

Aspect 11: The method of any of aspects 8 through 10, wherein the respective active use duration for the component carrier comprises a ratio between the respective duration over which the UE actively exchanges signaling via the component carrier and a second duration of the observation window.

Aspect 12: A UE for wireless communications, comprising: one or more memories storing processor-executable code; a transceiver; and one or more processors coupled with the one or more memories the transceiver, the one or more processors configured to perform a method of any of aspects 1 through 11.

Aspect 13: A UE for wireless communications, comprising at least one means for performing a method of any of aspects 1 through 11.

Aspect 14: A non-transitory computer-readable medium storing code for wireless communications, the code comprising instructions executable by one or more processors to perform a method of any of aspects 1 through 11.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code;
a transceiver; and
one or more processors coupled with the one or more memories and the transceiver, the one or more processors configured to:
receive, via the transceiver, control signaling that indicates a plurality of component carriers for communications by the UE;
receive, via the transceiver, one or more reference signals via a set of component carriers, wherein the set of component carriers comprises one or more component carriers, of the plurality of component carriers indicated via the control signaling, that are associated with an active use duration that is greater than a threshold duration, wherein the active use duration for a component carrier comprises a combined duration over which the UE actively communicates via the component carrier during an observation window; and
communicate using a beam that is selected from a plurality of candidate beams supported by the UE based at least in part on measurements of the one or more reference signals, wherein the beam is associated with a reference signal, of the one or more reference signals, having a metric that satisfies one or more beam selection conditions.

2. The UE of claim 1, wherein the one or more processors are further configured to:
receive, via the transceiver, one or more second reference signals via a second set of component carriers, wherein the second set of component carriers comprises one or more downlink component carriers, of the plurality of component carriers indicated via the control signaling, that are associated with respective second active use durations that are greater than a second threshold duration, and wherein the set of component carriers comprises one or more uplink component carriers.

3. The UE of claim 2, wherein:
the set of component carriers comprises a first quantity of component carriers that is different from a second quantity of component carriers included in the second set of component carriers; and
the set of component carriers comprises at least one component carrier that is not included in the second set of component carriers, the second set of component carriers comprises at least one component carrier that is not included in the set of component carriers, or both.

4. The UE of claim 2, wherein the one or more processors are further configured to:
communicate using a second beam that is selected from the plurality of candidate beams supported by the UE based at least in part on second measurements of the one or more second reference signals, wherein the second beam comprises a downlink beam associated with a second reference signal, of the one or more second reference signals, having a second metric that satisfies the one or more beam selection conditions, and wherein the beam comprises an uplink beam.

5. The UE of claim 2, wherein a second metric of a second reference signal for selection of a second beam of the plurality of candidate beams is different from the metric of the reference signal associated with the beam and used for selection of the beam based at least in part on the beam comprising an uplink beam and the second beam comprising a downlink beam.

6. The UE of claim 1, wherein the one or more processors are further configured to:
measure respective values of the metric associated with each reference signal of the one or more reference signals; and
select the beam from the plurality of candidate beams based at least in part on a value of the metric associated with the reference signal satisfying the one or more beam selection conditions, wherein communicating using the beam is based at least in part on selecting the beam.

7. The UE of claim 1, wherein the one or more processors are further configured to:
measure respective values of the metric associated with each reference signal of the one or more reference signals; and
select the beam from the plurality of candidate beams based at least in part on an average value of the metric across the one or more reference signals satisfying the one or more beam selection conditions, wherein communicating using the beam is based at least in part on selecting the beam.

8. The UE of claim 1, wherein the one or more processors are further configured to:
communicate via the plurality of component carriers during the observation window;
measure, for each component carrier of the plurality of component carriers based at least in part on communicating during the observation window, a respective active use duration for each component carrier; and
select the set of component carriers from among the plurality of component carriers based at least in part on the respective active use duration for each component carrier of the set of component carriers exceeding the threshold duration, wherein receiving the one or more reference signals via the set of component carriers is based at least in part on the selecting.

9. The UE of claim 8, wherein, to measure the respective active use duration for each component carrier, the one or more processors are further configured to:
measure, for each component carrier of the plurality of component carriers, a first respective active use duration over which the UE actively exchanges uplink signaling via the component carrier while communicating during the observation window, wherein a respective uplink active use duration is based at least in part on the first respective active use duration; and
measure, for each component carrier of the plurality of component carriers, a second respective active use duration over which the UE actively exchanges downlink signaling via the component carrier while communicating during the observation window, wherein a respective downlink active use duration is based at least on part on the second respective active use duration.

10. The UE of claim 9, wherein:
the threshold duration comprises a first threshold for inclusion of respective component carriers in the set of component carriers; and
a second threshold duration comprises a second threshold for inclusion of respective component carriers in a second set of component carriers.

11. The UE of claim 8, wherein the respective active use duration for the component carrier comprises a ratio between the respective duration over which the UE actively exchanges the signaling via the component carrier and a second duration of the observation window.

12. A method for wireless communications at a user equipment (UE), comprising:
receiving control signaling that indicates a plurality of component carriers for communications by the UE;
receiving one or more reference signals via a set of component carriers, wherein the set of component carriers comprises one or more component carriers, of the plurality of component carriers indicated via the control signaling, that are associated with an active use duration that is greater than a threshold duration, wherein the active use duration for a component carrier comprises a combined duration over which the UE actively communicates via the component carrier during an observation window; and
communicating using a beam that is selected from a plurality of candidate beams supported by the UE based at least in part on measurements of the one or more reference signals, wherein the beam is associated with a reference signal, of the one or more reference signals, having a metric that satisfies one or more beam selection conditions.

13. The method of claim 12, further comprising:
receiving one or more second reference signals via a second set of component carriers, wherein the second set of component carriers comprises one or more downlink component carriers, of the plurality of component carriers indicated via the control signaling, that are associated with respective second active use durations that are greater than a second threshold duration, and wherein the set of component carriers comprises one or more uplink component carriers.

14. The method of claim 13, wherein:
the set of component carriers comprises a first quantity of component carriers that is different from a second quantity of component carriers included in the second set of component carriers; and
the set of component carriers comprises at least one component carrier that is not included in the second set of component carriers, the second set of component carriers comprises at least one component carrier that is not included in the set of component carriers, or both.

15. The method of claim 13, further comprising:
communicating using a second beam that is selected from the plurality of candidate beams supported by the UE based at least in part on second measurements of the one or more second reference signals, wherein the second beam comprises a downlink beam associated with a second reference signal, of the one or more second reference signals, having a second metric that satisfies the one or more beam selection conditions, and wherein the beam comprises an uplink beam.

16. The method of claim 13, wherein a second metric of a second reference signal for selection of a second beam of the plurality of candidate beams is different from the metric of the reference signal associated with the beam and used for selection of the beam based at least in part on the beam comprising an uplink beam and the second beam comprising a downlink beam.

17. The method of claim 12, further comprising:
measuring respective values of the metric associated with each reference signal of the one or more reference signals; and
selecting the beam from the plurality of candidate beams based at least in part on a value of the metric associated with the reference signal satisfying the one or more beam selection conditions, wherein communicating using the beam is based at least in part on selecting the beam.

18. The method of claim 12, further comprising:
measuring respective values of the metric associated with each reference signal of the one or more reference signals; and
selecting the beam from the plurality of candidate beams based at least in part on an average value of the metric across the one or more reference signals satisfying the one or more beam selection conditions, wherein communicating using the beam is based at least in part on selecting the beam.

19. The method of claim 12, further comprising:
communicating via the plurality of component carriers during the observation window;
measuring, for each component carrier of the plurality of component carriers based at least in part on communicating during the observation window, a respective active use duration for the component carrier; and
selecting the set of component carriers from among the plurality of component carriers based at least in part on the respective active use duration for each component carrier of the set of component carriers exceeding the threshold duration, wherein receiving the one or more reference signals via the set of component carriers is based at least in part on the selecting.

20. A non-transitory computer-readable medium storing code for wireless communications at a user equipment (UE), the code comprising instructions executable by one or more processors to:
receive control signaling that indicates a plurality of component carriers for communications by the UE;
receive one or more reference signals via a set of component carriers, wherein the set of component carriers comprises one or more component carriers, of the plurality of component carriers indicated via the control signaling, that are associated with an active use duration that is greater than a threshold duration, wherein the active use duration for a component carrier comprises a combined duration over which the UE actively communicates via the component carrier during an observation window; and
communicate using a beam that is selected from a plurality of candidate beams supported by the UE based at least in part on measurements of the one or more reference signals, wherein the beam is associated with a reference signal, of the one or more reference signals, having a metric that satisfies one or more beam selection conditions.
